(19) United States
(12) Patent Application Publication
(10) Pub. No.: US 2026/0013656 A1
(43) Pub. Date: Jan. 15, 2026

(54) COMBINED CARPET

(71) Applicant: XUELEI WANG, TIANJIN (CN)

(72) Inventor: XUELEI WANG, TIANJIN (CN)

(21) Appl. No.: 19/331,563

(22) Filed: Sep. 17, 2025

Related U.S. Application Data
(63) Continuation-in-part of application No. 18/611,757, filed on Mar. 21, 2024, now Pat. No. 12,426,735.
Application No. 18/611,757 is a continuation-in-part of application No. 18/104,757, filed on Feb. 1, 2023, now abandoned.

(51) Int. Cl. A47G 27/02; B32B 3/04; B32B 3/30; B32B 5/02; B32B 5/06; B32B 5/26; B32B 37/06; B32B 37/10; B32B 37/12; B32B 38/00

(52) U.S. Cl. CPC A47G 27/0212; B32B 3/04; B32B 3/30; B32B 5/026; B32B 5/073; B32B 5/26; B32B 37/06; B32B 37/10; B32B 37/1207; B32B 37/1284; B32B 38/0012; B32B 2037/1215; B32B 2038/002; B32B 2262/0276; B32B 2262/067; B32B 2262/152; B32B 2305/182; B32B 2307/536; B32B 2307/72; B32B 2307/7375; B32B 2307/744; B32B 2471/04

(57) ABSTRACT

A combined carpet is provided. The combined carpet includes an upper carpet body and a lower carpet body. The upper carpet body includes a first layer and a first attaching layer under the first layer; the lower carpet body is configured to be paved between the upper carpet and an object surface, and includes a second attaching layer and a second layer under the second attaching layer. An edge area of the first attaching layer extends beyond the second attaching layer to contact the object surface and does not overlap with the second attaching layer, a main area of the first attaching layer and the second attaching layer body realize a relative rest through a static friction force, to prevent relative movement when the upper and lower carpet bodies are connected, thereby forming a detachable combination between the upper carpet body and the lower carpet body.

### CROSS-REFERENCE TO RELATED APPLICATIONS

This application is a Continuation-in-Part of the U.S. application Ser. No. 18/611,757 filed on Mar. 21, 2024, and entitled “Combined carpet”, now pending, the entire disclosures of which are incorporated herein by reference.

### TECHNICAL FIELD

The present disclosure relates to the carpet field, and in particular to a combined carpet.

### BACKGROUND

With the diverse development of the social culture, a carpet is more widely used in human production and life. For better shock absorption and sound insulation effects as well as a comfortable foot feeling, the carpet usually adopts a heavier fabric, however the fabric is heavier and difficultly put into a washing machine, making the cleaning difficult, and moreover when the carpet has a great area, the cleaning is more difficult, which brings a poor cleaning experience to users.

At present, in order to solve the problem that the carpet is heavier and not easy to clean, the carpet on the market is mostly woven into a thinner carpet, but the thinner carpet has poor shock absorption and sound insulation effects, leading to a poor texture and a poor comfort level.

### SUMMARY

To overcome the deficiencies in the existing technology, the present disclosure provides a combined carpet that may be used separately or used in combination, and is easy to clean.

The technical solution adopted by the present disclosure to solve the technical problem is as follows.

In one aspect, a combined carpet includes:
an upper carpet body that includes a first attaching layer;
a lower carpet body that is paved between the upper carpet and an object surface, and the lower carpet body includes a second attaching layer;
wherein an edge area of the first attaching layer extends beyond the second attaching layer to contact the object surface and does not overlap with the second attaching layer, a main area of the first attaching layer and the second attaching layer body realize a relative rest through a static friction force, to prevent relative movement when the upper and lower carpet bodies are connected, thereby forming a detachable combination between the upper carpet body and the lower carpet body.

In another aspect, a combined carpet includes:
an upper carpet body that includes a first layer and a first attaching layer under the first layer;
a lower carpet body that is paved between the upper carpet and an object surface, and the lower carpet body includes a second attaching layer and a second layer under the second attaching layer;
wherein an edge area of the first attaching layer extends beyond the second attaching layer to contact the object surface and does not overlap with the second attaching layer, a main area of the first attaching layer and the second attaching layer realize a relative rest through a mechanical interlocking structure to prevent relative movement when the upper and lower carpet bodies are connected, thereby forming a detachable combination between the upper carpet body and the lower carpet body.

Compared with the prior art, the combined carpet provided by the present disclosure adopts the first attaching layer to resist to the second attaching layer, i.e., the first attaching layer is arranged adjacent to the second attaching layer, a friction force or mechanical interlocking structure existing therebetween is used to make the first attaching layer and the second attaching layer keep a relative rest; and when human or pets walk on the carpet, a force in a horizontal direction is less than the static friction force or mechanical interlocking force therebetween, such that the first attaching layer and the second attaching layer can still keep the relative rest to avoid a separation thereof. Meanwhile, the first attaching layer and the second attaching layer may be detachably combined such that the upper carpet body and the lower carpet body can be used in combination or used separately according to demands.

When combined use is adopted, the thickness of the carpet may be increased effectively, such that the combined carpet has better shock absorption, sound insulation effects and a high comfortable level; when separate use is required in some scenarios, the upper carpet body or the lower carpet body may be used separately, such that the combined carpet has diversified using scenarios, and the commonality thereof is improved. In addition, since the size of the lower carpet body is less than that of the upper carpet body, the lower carpet body can be completely covered by the upper carpet body, is always between the upper carpet body and the object surface such as the floor, and can keep clean and tidy, and therefore frequent cleaning for the lower carpet body is not required; and when the carpet needs to be cleaned, the frequently contacted upper carpet body needs to be cleaned and tidied only, and at this time the upper carpet body is directly separated from the lower carpet body for cleaning, to keep the combined carpet clean and tidy.

### BRIEF DESCRIPTION OF THE DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a solid schematic view of a combined carpet according to a first embodiment of present disclosure.

FIG. 2 is an exploded view of a combined carpet according to a first embodiment of present disclosure.

FIG. 3 is a cross sectional view of a combined carpet according to a first embodiment of present disclosure.

FIG. 4 is a partially enlarged view of a part A in FIG. 3.

FIG. 5 is a cross sectional view of a combined carpet used in combination.

FIG. 6 is shows a bottom of an upper carpet body according to one modified embodiment of the present disclosure.

FIG. 7 is a cross sectional view of an upper carpet body according to one modified embodiment of the present disclosure.

FIG. 8 shows a bottom of a lower carpet body according to a first embodiment of present disclosure.

FIG. 9 is a partially cross sectional view of a lower carpet body according to a second embodiment of present disclosure.

FIG. 10 a partially cross sectional view of a lower carpet body according to a third embodiment of present disclosure.

FIG. 11 is a schematic view of a combined carpet according to a fourth embodiment of present disclosure.

FIG. 12 is a schematic view of a combined carpet used in combination according to a fifth embodiment of present disclosure.

FIG. 13 is a schematic view of a combined carpet used in combination according to a sixth embodiment of present disclosure.

FIG. 14 is a schematic view of a combined carpet according to a seventh embodiment of present disclosure.

FIG. 15 is an exploded view of a combined carpet according to a seventh embodiment of present disclosure.

FIG. 16 is another exploded view of a combined carpet according to a seventh embodiment of present disclosure.

FIG. 17 is a cross sectional view of a combined carpet according to a seventh embodiment of present disclosure.

FIG. 18 is a partially enlarged view of FIG. 17.

FIG. 19 shows a fabric structure of the first attaching layer of the upper carpet body according to a seventh embodiment of the present disclosure.

FIG. 20 shows a fabric structure of the second attaching layer of the lower carpet body according to a seventh embodiment of the present disclosure.

FIG. 21 shows a fiber structure of the first attaching layer of the upper carpet body according to a seventh embodiment of the present disclosure.

FIG. 22 shows a fiber structure of the second attaching layer of the lower carpet body according to a seventh embodiment of the present disclosure.

### DETAILED DESCRIPTION OF THE EMBODIMENTS

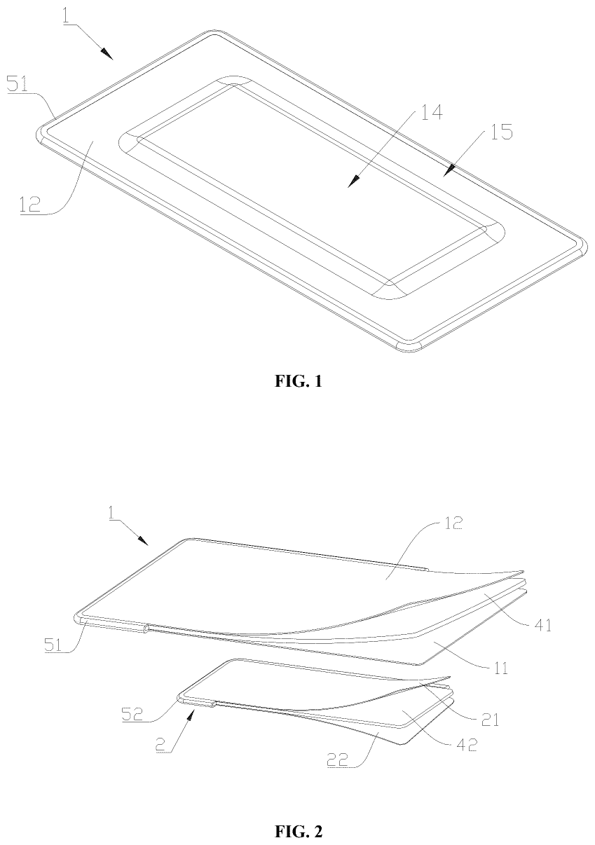

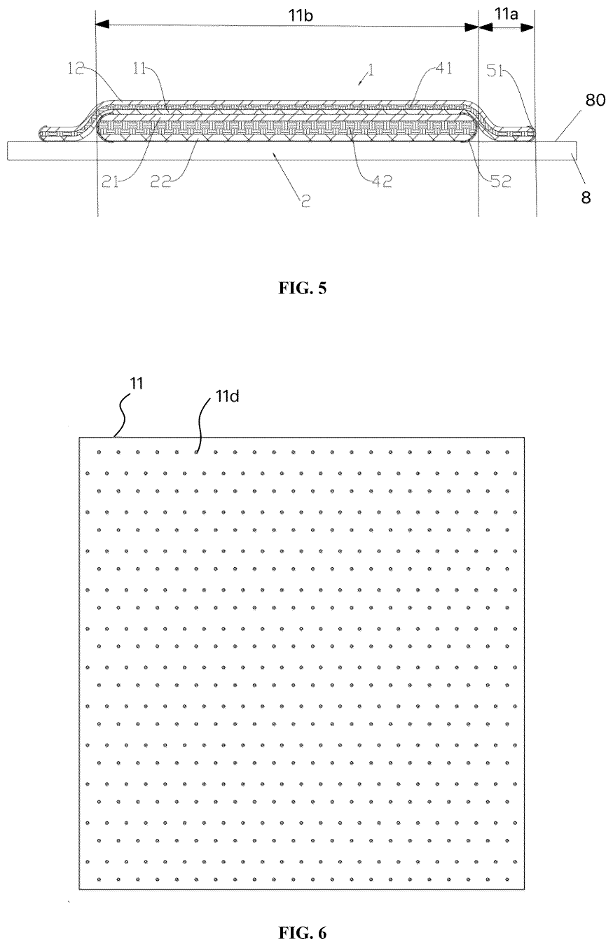

Referring to FIG. 1 and FIG. 5, the present disclosure provides a combined carpet, including an upper carpet body 1 and a lower carpet body 2; the upper carpet body 1 includes a first anti slip layer 11, the lower carpet body 2 includes a first flexible fabric layer 21 arranged at a top of the lower carpet body 2, a size of the lower carpet body 2 is less than that of the upper carpet body 1 such that the lower carpet body 2 can be completely covered by the upper carpet body 1, and the upper carpet body 1 is covered on the first flexible fabric layer 21 of the lower carpet body 2 by the first anti slip layer 11 thereof, such that upper carpet body 1 and the lower carpet body 2 realize a relative rest through a static friction force, to form a detachable combination.

It can be understood that the first anti slip layer 11 can also be referred to as a first attaching layer, and the first flexible fabric layer 21 can also be referred to as a second attaching layer. In this embodiment, an edge area 11a of the first attaching layer (i.e., the first anti slip layer 11) extends beyond the second attaching layer (i.e., the first flexible fabric layer 21) to contact the surface 80 of external objects (such as the floor 8) and does not overlap with the second attaching layer (i.e., the first flexible fabric layer 21). The main area 11b of the first attaching layer (i.e., the first anti slip layer 11) and the second attaching layer (i.e., the first flexible fabric layer 21) are detachably attached by a static friction force to prevent relative movement when connecting the upper carpet body 1 and the lower carpet body 2.

Specifically, in the present disclosure, the upper carpet body 1 covering the lower carpet body 2 completely means that the lower carpet body 2 is paved on a horizontal floor when the combined carpet is paved on an object surface such as a floor, and a horizontal projection of the lower carpet body 2 on the floor is completely covered by that of the upper carpet body 1 on the floor when the upper carpet body 1 is paved on the lower carpet body 2.

Through the foregoing structure setting, the combined carpet provided by the present disclosure adopts the first anti slip layer 11 to resist to the first flexible fabric layer 21, a friction force existing therebetween is used to make the upper carpet body 1 and the lower carpet body 2 keep a relative rest; and when human or pets walk on the carpet, a force in a horizontal direction is less than the static friction force therebetween, such that the the upper carpet body 1 and the lower carpet body 2 can still keep the relative rest to avoid a separation thereof. Meanwhile, the the upper carpet body 1 and the lower carpet body 2 may be detachably combined such that the upper carpet body 1 and the lower carpet body 2 can be used in combination or used separately according to demands; when combined use is adopted, the thickness of the carpet may be increased effectively, such that the combined carpet has better shock absorption, sound insulation effects and a high comfortable level; when separate use is required in some scenarios, the upper carpet body 1 or the lower carpet body 2 may be used separately, such that the combined carpet has diversified using scenarios, and the commonality thereof is improved. In addition, since the size of the lower carpet body 2 is less than that of the upper carpet body 1, the lower carpet body 2 can be completely covered by the upper carpet body 1, is always between the upper carpet body 1 and the object surface such as the floor, and can keep clean and tidy, and therefore frequent cleaning for the lower carpet body 2 is not required; and when the carpet needs to be cleaned, the frequently contacted upper carpet body 1 needs to be cleaned and tidied only, and at this time the upper carpet body 1 is directly separated from the lower carpet body 2 for cleaning, to keep the combined carpet clean and tidy. Since the size of the lower carpet body 2 is less than that of the upper carpet body 1, the part that does not resist to the first flexible fabric layer 21 in the first anti slip layer 11 of the upper carpet body 1 may also be in contact with the object surface such as the floor and also improve the friction between the upper carpet body 1 and the ground, to prevent the upper carpet body 1 skidding from the floor, thereby improving the using effect of the carpet.

Further, since the upper carpet body 1 may be mutually separated from the lower carpet body 2, both the upper carpet body 1 and the lower carpet body 2 may be used as the carpet separately, so as to effectively improve the commonality of the carpet provided by the present disclosure, and users may select the upper carpet body and the lower carpet body according to different using scenarios. For example, when placing space is small, it may consider using the lower carpet body 2, and since the first flexible fabric layer 21 is disposed at the top of the lower carpet body 2, the lower carpet body 2 has a better appearance, a better touch, a better decoration effect and a capability of reducing noise, so as to ensure the experience of using the lower carpet body 2 separately. When the ground is wet, it may consider using the upper carpet body 1, and since the first anti slip layer 11 is disposed at the bottom of the upper carpet body 1, the upper carpet body 1 has a better anti-skidding effect, so as to ensure the experience of using the upper carpet body 1 separately.

In this embodiment, both the upper carpet body 1 and the lower carpet body 2 are the product with a solid structure, and have a certain thickness. Specifically, a thickness of the upper carpet body 1 is less than or equal to that of the lower carpet body 2. In this embodiment, to make the upper carpet body 1 be cleaned more easily, the thickness of the upper carpet body 1 is less than that of the lower carpet body 2. In the present disclosure, the thickness of the upper carpet body 1 and the lower carpet body 2 is the total sum of the thickness of various layers of the carpet body, and when the surface of the carpet body has the fluff, the height of the fluff is not calculated in the thickness. In another embodiment, the fluff on the surface of the carpet body may be set highly, such that the product has a better experience. The upper carpet body 1 is designed to be thinner than the lower carpet body 2, such that the upper carpet body 1 can be easily cleaned during cleaning; and the thicker lower carpet body 2 can increase the thickness of the combined carpet, making the whole combined carpet more comfortable.

Please refer to FIG. 2 to FIG. 5, in this embodiment, the upper carpet body 1 further includes a connecting layer 41 and a first layer 12, the connecting layer 41 is arranged on one side of the first anti slip layer 11 that is away from the lower carpet body 2, the first layer 12 is arranged on one side of the connecting layer 41 that is away from the first anti slip layer 11.

In some embodiments, the first anti slip layer 11 comprises a rubber layer or a plastic layer, which can be directly attached to the connecting layer 41 by hot pressing, point molding, hot melt adhesive spraying, or hot melt adhesive roller rolling.

In an alternative embodiment, the connecting layer 41 is omitted, the rubber layer or plastic layer can be directly attached to the first layer 12 by hot pressing, point molding, hot melt adhesive spraying, or hot melt adhesive roller rolling.

As shown in FIG. 6, further in a modified embodiment, the rubber layer or plastic layer may include anti slip patterns or anti slip protrusions 11d, which can be directly attached to the connecting layer 41 through hot pressing, point molding, hot melt adhesive spraying, or hot melt adhesive roller rolling. Alternatively, when the connecting layer 41 is omitted, the anti slip patterns or anti slip protrusions 11d can be directly attached to the first layer 12 through hot pressing, point molding, hot melt adhesive spraying, or hot melt adhesive roller rolling.

Among them, regarding the formation of multiple anti slip protrusions 11d, the hot melt adhesive spraying process can be achieved by using patterned mesh covers in conjunction with spraying equipment, and the hot melt adhesive roller rolling process can be transferred or printed through patterned rollers.

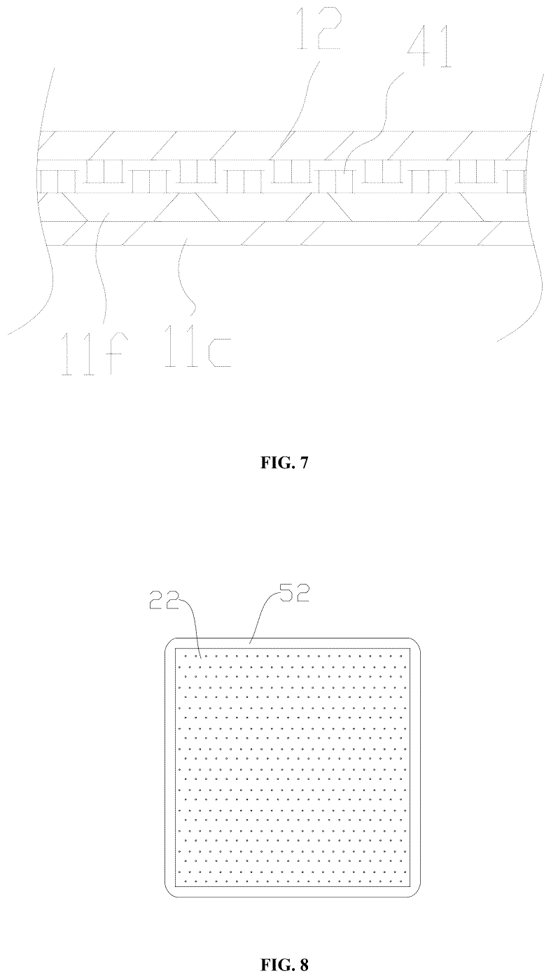

As shown in FIG. 7, in another modified embodiment, the first anti slip layer 11 includes a bottom layer 11f and a rubber or plastic layer 11c. The bottom layer 11f can be a cotton cloth but is not limited to cotton cloth. In some embodiments, a layer of cotton cloth (the bottom layer 11f) can be added below or above the rubber or plastic layer 11c for hot pressing to form the first anti slip layer 11. In other embodiments, the rubber or plastic layer can also be directly attached to the bottom layer 11f by hot melt adhesive spraying or hot melt adhesive roller rolling. The bottom layer 11f can be the first fabric layer.

Specifically, the rubber layer or plastic layer can be made of thermoplastic vulcanized rubber, also known as thermoplastic rubber or TPR or TPV. The connecting layer 41 and the first layer 12 are provided on the upper carpet body 1, so that the upper carpet body 1 can also be separately laid on the surface of an object for use, and has certain shock absorption and sound insulation effects. In addition, the use of a rubber layer with anti slip patterns can improve the anti slip performance of the upper carpet body 1, and has a certain degree of elasticity and waterproofness, which can effectively enhance the anti slip performance of the first anti slip layer 11 and increase its usage scenarios; after setting the connecting layer 41, the comfort of the combined carpet can be further improved; adding a layer of cotton cloth under the rubber layer for hot pressing is more comfortable than directly using the rubber layer, if the rubber layer is used directly, the user does not want to use the lower carpet body and can use the upper carpet body directly. The upper carpet body can also be laid directly on the ground, and it will not move relative to the ground. Adding a layer of cotton cloth under the rubber layer for hot pressing further increases the overall comfort of the carpet compared to only having the rubber layer, the cotton cloth can provide better breathability and soft touch, but the friction force is relatively small compared to directly laying on the ground, making it easy to move, however, compared to laying on the lower carpet body, the lower carpet body also has a certain friction force, therefore, the upper carpet body is less likely to move relative to the lower carpet body and also improves comfort. In addition to the above-mentioned anti slip structure, the first anti slip layer can also be hot melt adhesive, which is attached to the upper structure by spraying or rolling. The upper carpet body 1 in the present invention can be used in areas with high pedestrian flow or low requirements for sound insulation and shock absorption, such as kitchens, living rooms, dining rooms, utility rooms, areas under furniture, lobbies of commercial office buildings, etc. Moreover, the upper carpet body 1 is thin and soft, and can be folded and carried, making it suitable for temporary use during picnics and camping.

In this embodiment, the first anti slip layer 11 further comprises a first fabric layer, which is located on the side of the rubber layer away from the first layer 12. The first fabric layer is attached to the rubber layer using a hot pressing process. Specifically, the first fabric layer is a cotton cloth, which is directly attached to the rubber layer by hot pressing. Hot pressing the first fabric layer onto the rubber layer can slow down the aging rate of the rubber layer, thereby improving its service life. It can also increase the friction of the first anti slip layer 11, thereby improving its anti slip ability. This ensures stable anti slip performance whether used alone or in combination, and enhances the anti slip performance of the combined carpet. By setting the first layer 12, the upper carpet body 1 is softer, with better tactile and decorative effects, as well as reducing noise. This makes the upper carpet body 1 have a certain degree of shock absorption and sound insulation when used alone, with higher comfort and better results when used in combination.

The lower carpet body 2 also includes a second anti slip layer 22, which is located on the side of the first flexible fabric layer 21 away from the upper carpet body 1. The second anti slip layer 22 is used to contact the surface of the object. Due to the second anti slip layer 22, the lower carpet body 2 has good anti slip performance whether used alone or in combination, thereby enhancing the product's user experience.

Specifically, the lower carpet body 2 further comprises a second layer 42, which is located between the first flexible fabric layer 21 and the second anti slip layer 22. Specifically, a thickness of the second layer 42 is thicker than that of the connecting layer 41. Setting the second layer 42 can increase the thickness of the lower carpet body 2, improve the comfort and user experience of the product, and the thickness of the second layer 42 is thicker, making the overall thickness of the combined carpet thicker, improving shock absorption and sound insulation effects, thereby enhancing the comfort of the product. The lower carpet body 2 in the present invention can be used in places with low pedestrian flow or high requirements for shock absorption and sound insulation, such as attic, bedroom floor, stairs, etc., to maintain a quiet and comfortable environment.

In some embodiments, the connecting layer 41 may be omitted, i.e., the upper carpet body 1 can be a double-layer structure composed of a first attaching layer 11 and a first layer 12. The first layer 12 is located on the outermost side of the upper part of the upper carpet body 1, for contact with the user. The material of the first layer 12 includes cotton, polyester, nylon, and/or modal, and the material of the second layer 42 includes wool, polyester, acrylic, synthetic fiber, and/or polypropylene.

Please refer to FIG. 8, in one embodiment of the present invention, the second anti slip layer 22 comprises silicone gel, which is attached to the surface of the second layer 42 on the side away from the first flexible fabric layer 21 using a point molding process. The use of point molding technology to allow silicone on the second layer 42 not only increases the friction of the product, improves its anti slip ability, but also makes the product more beautiful. In addition, silicone is non-toxic and odorless, more environmentally friendly, and has a soft touch and good user experience. In other embodiments, plastic can also be used instead of silicone to reduce costs.

Please refer to FIG. 9, in another embodiment of the present invention, the second anti slip layer 22 comprises a second fabric layer 222 and a hot melt adhesive layer 221. The second fabric layer 222 is compounded on the side of the second layer 42 away from the first flexible fabric layer 21, and the hot melt adhesive layer 221 is coated on the side surface of the second fabric layer 222 away from the second layer 42. The coating method can be spray coating to apply hot melt adhesive onto the second fabric layer 222, scraping the hot melt adhesive onto the second fabric layer 222 with a scraper, rolling coating to brush the hot melt adhesive onto a roller, immersion coating, brush coating, etc., as long as the hot melt adhesive can be coated onto the second fabric layer 222. Coating hot melt adhesive onto the second fabric layer 222 not only is it non-toxic and environmentally friendly, but also has a good tactile sensation and a certain degree of viscosity. This creates a certain viscosity between the lower carpet body 2 and the surface of the object, such as the floor, allowing the lower carpet body 2 to adhere to the surface of the object in a way that enhances the anti slip ability of the carpet.

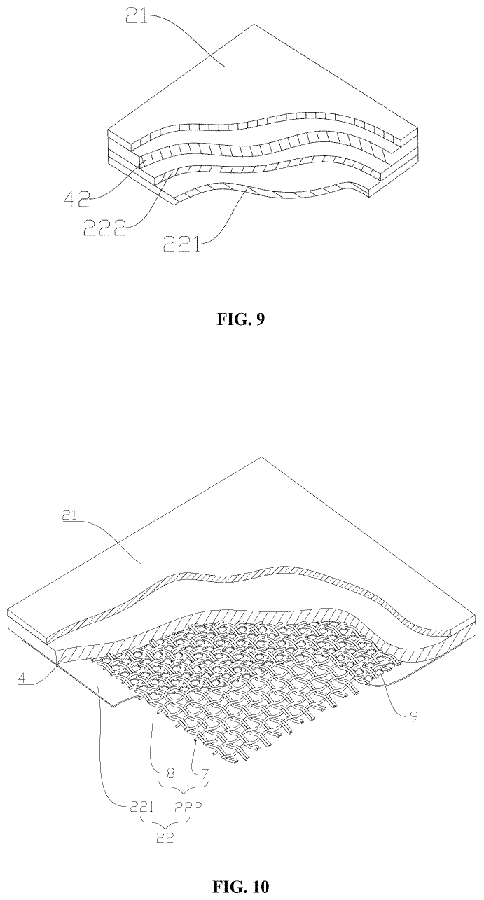

Specifically, please refer to FIG. 10, the second fabric layer 222 includes several first fabric threads 7 and several second fabric threads 8, which are arranged in a crossing manner to form the second fabric layer 222; the hot melt adhesive adheres to the first weaving thread 7 and the second weaving thread 8, and of course, some of the hot melt adhesive may also enter the first weaving thread 7 and the second weaving thread 8. Due to the weaving method used by the first weaving thread 7 and the second weaving thread 8 to form the second fabric layer 222, weaving holes 9 will be formed between the first weaving thread 7 and the second weaving thread 8. When hot melt adhesive is applied to the second fabric layer 222, the weaving holes 9 will not be blocked, thereby improving the anti slip performance and making the lower carpet body 2 breathable, effectively enhancing the effectiveness of carpet use.

The first weaving thread 7 and the second weaving thread 8 are both cotton threads, which have good breathability, moisture absorption, and more stable adhesion of thermoplastic rubber. Of course, the first weaving thread and the second weaving thread can also be hemp fiber thread, silk thread, synthetic fiber thread, etc. In other embodiments, the same method as the second fabric layer 222 can be used to obtain the first fabric layer.

In this embodiment, both the connecting layer 41 and the second layer 42 are needle punched non-woven fabrics; the first flexible fabric layer 21 and the first layer 12 both consist of polyester material. Specifically, the first flexible fabric layer 21 and the first layer 12 are rope velvet layers woven from polyester, the rope velvet has a full and soft surface, good drape, good water absorption, anti-static, antibacterial and other functions, effectively improving the use effect of the carpet.

In other embodiments, the first flexible fabric layer 21 and the first layer 12 can be made of different materials, which can be a rope layer, a wool layer, a nylon layer, a polyester layer, or a flexible material layer such as cotton; In order to make the product waterproof, it can also be a hydrophobic material layer, or a combination of flexible materials and hydrophobic materials woven in a certain proportion, which is not limited in this application. In other embodiments, the connecting layer 41 and the second layer 42 can also be made of flexible materials such as chemical fibers, coconut fibers, pure cotton, etc., as long as they can achieve buffering and shock absorption, reduce noise, and improve comfort.

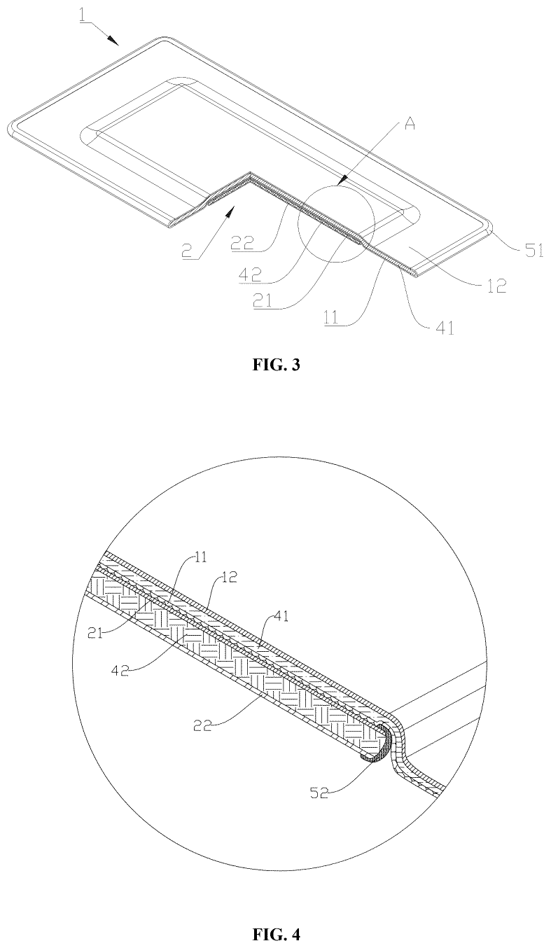

Please refer to FIG. 3. In this embodiment, the upper carpet body 1 further comprises a first knitted edge 51, which is arranged along the side of the upper carpet body 1 and wraps the edges of the first layer 12, the connecting layer 41, and the first anti slip layer 11. In other embodiments, the first knitted edge 51 may also only wrap the edges of the first layer 12 and the connecting layer 41. By setting up the above structure, while improving the wear resistance of the side edges of the upper carpet body 1, the original texture of the upper carpet body 1 can also be retained, making it difficult for the upper carpet body 1 to detach, which can further enhance the service life of the carpet body 1.

Please refer to FIG. 4, the lower carpet body 2 further comprises a second knitted edge 52, which is arranged along the side of the lower carpet body 2 and wraps the edges of the first flexible fabric layer 21, the second layer 42, and the second anti slip layer 22. By setting up the above structure, the wear resistance of the side edges of the lower carpet body 2 can be improved while also retaining the original texture of the carpet body 2, making it less likely for the lower carpet body 2 to detach, which can further enhance the service life of the carpet.

In the embodiments of the present invention, the upper carpet body 1 and the lower carpet body 2 can be circular, rectangular, or other polygonal shapes, as well as different combinations of polygons, as shown in FIG. 11, which illustrates a schematic diagram of a circular combined carpet. In order to provide better comfort for the use of the combined carpet and to facilitate the calculation and cutting of carpet dimensions during production, the present invention adopts restrictions on the surface area (top surface area) dimensions of the upper carpet body 1 and the lower carpet body 2, specifically, the percentage ratio of the surface area of the lower carpet body 2 to the surface area of the upper carpet body 1 ranges from 50% to 95%. Specifically, the percentage ratio of the area of the lower carpet body 2 to the area of the upper carpet body 1 can be 50%, 55%, 60%, 65%, 70%, 75%, 80%, 85%, 90%, 95%, and other values as long as they are within the aforementioned range.

In order to further improve the comfort of using the combination carpet, it is necessary to ensure the maximum overlap area between the two during use, and to avoid problems such as edge curling, displacement, and difficulty in laying on the upper carpet body 1. In the present invention, the percentage ratio range of the area of the lower carpet body 2 to the area of the upper carpet body 1 will be limited to 55%-90%, preferably 55%-80%. In the embodiments of the present invention, the specific shapes of the upper carpet body 1 and the lower carpet body 2 are not limited, and their projections on the floor can be rectangular, circular, or other shapes, as long as the percentage ratio of the area of the lower carpet body 2 to the area of the upper carpet body 1 is within the aforementioned range.

In this embodiment, both the upper carpet body 1 and the lower carpet body 2 adopt a rectangular shape, with long and short sides and a certain height, therefore, the upper carpet body 1 and the lower carpet body 2 have length, width, and thickness. In order to facilitate the calculation and cutting of production, the embodiment of the present invention adopts a restriction on the ratio of the length and width of the upper carpet body 1 and the lower carpet body 2. The ratio of the length of the lower carpet body 2 to the length of the upper carpet body 1 is limited to 60%-100%, specifically, the ratio of the length of the lower carpet body 2 to the length of the upper carpet body 1 can be 60%, 65%, 70%, 75%, 80%, 85%, 90%, 95%, or 100%, the ratio can also be any other value as long as it is within the aforementioned range. In order to further improve the comfort and wider application scenarios of the combination carpet, and to enable at least part of the long or wide edge of the upper carpet 1 to be laid on the surface of an object such as a floor after combination, thereby avoiding problems such as edge warping, displacement, and difficulty in laying the upper carpet body 1, the ratio range of the length of the lower carpet body 2 to the upper carpet body 1 is limited to 75%-95%, preferably 80%-95%. Meanwhile, the width ratio of the lower carpet body 2 to the upper carpet body 1 is limited to between 100% and 55%. The width ratio of the lower carpet body 2 to the upper carpet body 1 can be 55%, 60%, 65%, 70%, 75%, 80%, 85%, 90%, 95%, or 100%, and it can also be any other value as long as it falls within the aforementioned range. Preferably, the width ratio of the lower carpet body 2 to the upper carpet body 1 is limited to between 95% and 60%. Specifically, in the embodiments of the present invention, the width ratio of the lower carpet body 2 to the upper carpet body 1 is limited to between 90% and 60%, which can improve the comfort of the combined carpet and reduce problems during use.

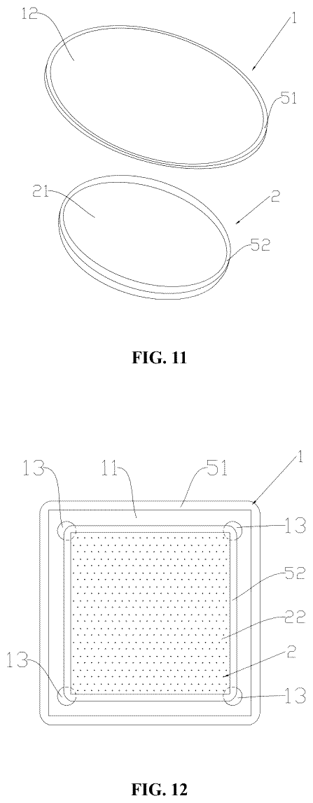

Please refer to FIG. 12, in this embodiment, there is also an alignment mark 13 on the surface of the first anti slip layer 11 facing the first flexible fabric layer 21, the alignment mark 13 is used to align the long or short sides or corners of the lower carpet body 2, so that when the upper carpet body 1 is laid on top of the lower carpet body 2, the lower carpet body 2 is located below the preset position of the upper carpet body 1. In this embodiment, the alignment mark 13 adopts a circular pattern style. When laying a combination carpet, the corners of the lower carpet body 2 can be aligned with the alignment mark 13. Then, the combination carpet is laid on the floor, and the lower carpet body 2 can be laid at the preset position of the upper carpet body 1. It can be understood that the preset position is the area limited by the alignment mark 13. Setting the alignment mark 13 can facilitate the alignment of the lower carpet body 2 and the upper carpet body 1 during laying, thereby making the combination laying more convenient.

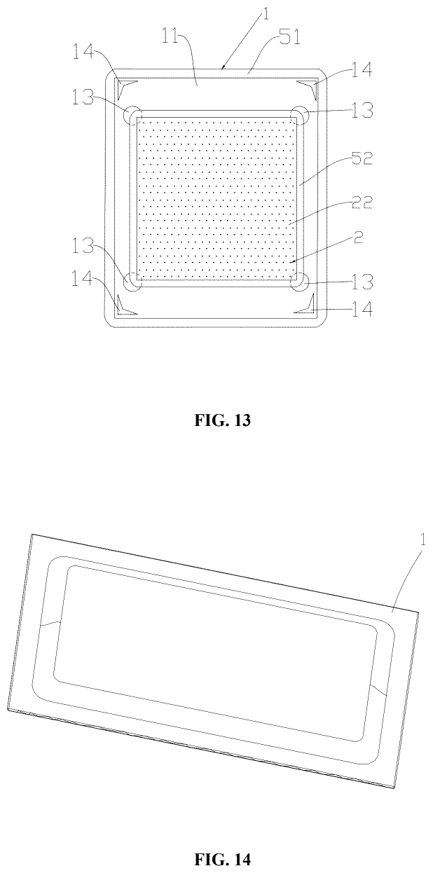

Please refer to FIG. 13, in other embodiments, the combined carpet further includes adhesive tape 14, which is applied in four directions of the first anti slip layer 11, taking a rectangular shape as an example. The four directions refer to the four corners, to attach the upper carpet body 1 to the surface of the object. The adhesive tape 14 can be used alone or directly attached to the first anti slip layer 11, and the sticker can be peeled off during use. This application does not impose any restrictions. By setting up the adhesive tape 14, the upper carpet body 1 can be more firmly attached to the surface of the object, avoiding relative sliding between the upper carpet body 1 and the lower carpet body 2, while further ensuring the stability of the combined carpet laid on the surface of the object and improving its anti slip ability.

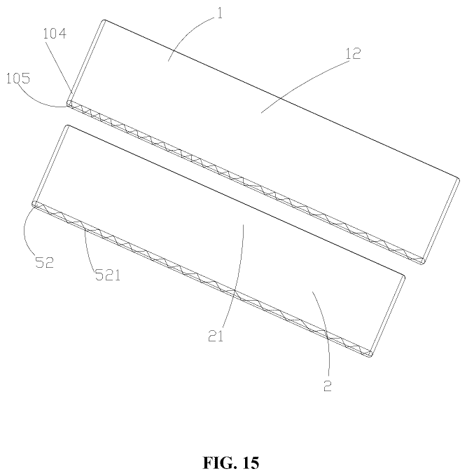

Referring to FIGS. 14-16, the seventh embodiment of the present application provides a combination carpet, which includes an upper carpet body 1 and a lower carpet body 2. The upper carpet body 1 includes a first attaching layer 11; the lower carpet body 2 is used to lay between the upper carpet body 1 and an object surface, and the lower carpet body 2 includes a second attaching layer 21. An edge area 11a of the first attaching layer 11 extends beyond the second attaching layer 21 to contact the surface 80 of the object (such as the surface of the floor 8) and does not overlap with the second attaching layer 21, that is, the upper carpet body 1 covers the lower carpet body 2 and has a larger surface area than the lower carpet body 2. A main area 11b of the first attaching layer 11 is detachably connected to the second attaching layer 21 through a mechanical interlocking structure to prevent relative movement when the upper carpet body 1 and the lower carpet body 2 are connected. It can be understood that the mechanical interlocking structure between the first attaching layer 11 and the second attaching layer 21 can generate static friction between the first attaching layer 11 and the second attaching layer 21, in order to prevent relative movement of the upper carpet body 1 or the lower carpet body 2 when external forces are applied.

Static friction force refers to the force that impedes the relative motion trend of an object on the surface of another object when it has a relative motion trend but no relative motion occurs. In other words, there is a relative motion trend between the main area 11b of the first attaching layer 11 and the second attaching layer 21, but no relative motion occurs yet, in this way, the upper attaching layer 1 is placed on the lower attaching layer 2, and its gravity is applied to the lower attaching layer 2, combined with the mechanical interlocking structure's bonding force, so that static friction force can be generated between the upper attaching layer 1 and the lower attaching layer 2 to create a detachable connection. That is to say, compared to existing technology, using the first attaching layer 11 and the second attaching layer 21, the second attaching layer 21 can be utilized to achieve a detachable connection. There is a mechanical interlocking structure between them, which allows them to remain relatively stationary; When a person or animal walks on a carpet, the horizontal force is less than the static friction force between the two (including the gravity of the carpet body 1 and the binding force of the mechanical interlocking structure), allowing the two to continue to remain relatively stationary and avoid separation.

Meanwhile, the detachable combination between the two allows the upper and lower blanket bodies to be used in combination or separately as needed; when used in combination, it can effectively increase the thickness of the carpet, making the combined carpet have good shock absorption and sound insulation effects, and high comfort; when some scenarios require separate use, the upper or lower carpet body can be used separately to diversify the usage scenarios of the combined carpet and enhance its versatility. In addition, due to the smaller surface size of the lower carpet body compared to the upper carpet body, it can be completely covered by the upper carpet body, so that the lower carpet body is always between the upper carpet body and the surface of the object such as the floor, thus keeping the lower carpet body clean and tidy. Therefore, the lower carpet body does not need to be cleaned frequently; when it is necessary to clean the carpet, simply clean and tidy the upper carpet body that is frequently in contact with it, at this time, directly separate the upper carpet body from the lower carpet body and clean it to keep the carpet clean and tidy.

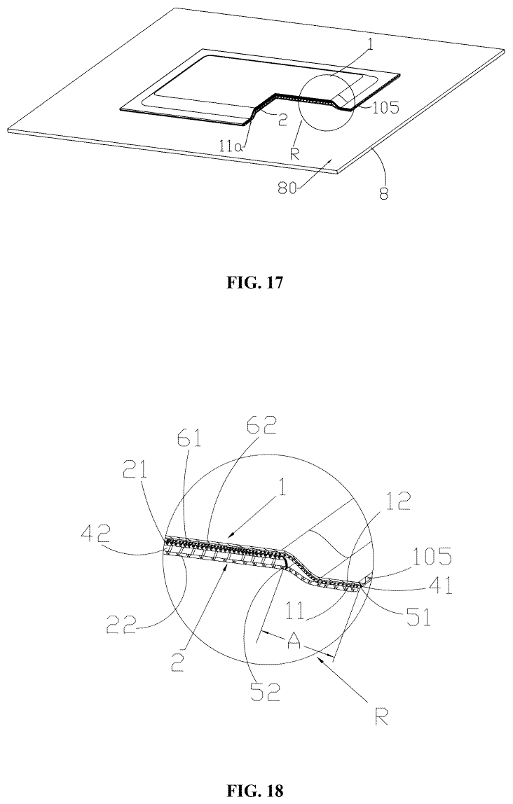

Furthermore, please refer to FIGS. 17 and 18, the upper carpet body 1 also includes a first layer 12 located on the side of the first attaching layer 11 away from the second attaching layer 21, so that the upper carpet body 1 can also be separately laid on the surface of an object for use, and has certain shock absorption and sound insulation effects; the lower carpet body 2 also includes a second layer 42 located on the side of the second attaching layer 21 away from the first attaching layer 11. Setting the second layer 42 can increase the thickness of the lower carpet body 2, improve the comfort and user experience of the product, and the thickness of the second layer 42 is thicker, making the overall thickness of the combined carpet thicker, improving the shock absorption and sound insulation effect, thereby enhancing the comfort of the product. Using the lower carpet body 2 alone can be used in places with low pedestrian flow or high requirements for shock absorption and sound insulation, such as attic, bedroom floor, stairs, etc., to maintain a quiet and comfortable environment.

Furthermore, the first layer 12 is located on the outermost side of the upper part of the upper carpet body 1 for contact with the user. The materials of the first layer 12 include cotton, polyester, polypropylene, wool, nylon, and/or modal, which provide higher comfort and better user experience.

Furthermore, the upper carpet body 1 also includes a connecting layer 41 located between the first layer 12 and the first attaching layer 11. After setting up the connecting layer 41, the comfort of the combined carpet can be further improved.

Furthermore, the material of the second layer 42 includes wool, polyester, acrylic, non-woven fabric, sponge, synthetic fiber, and/or polypropylene. If the thickness of the second layer 42 is thicker than that of the connecting layer 41, the thickness of the second layer 42 is set to be thicker, making the overall thickness of the combined carpet thicker, improving shock absorption and sound insulation effects, and thus enhancing the comfort of the product.

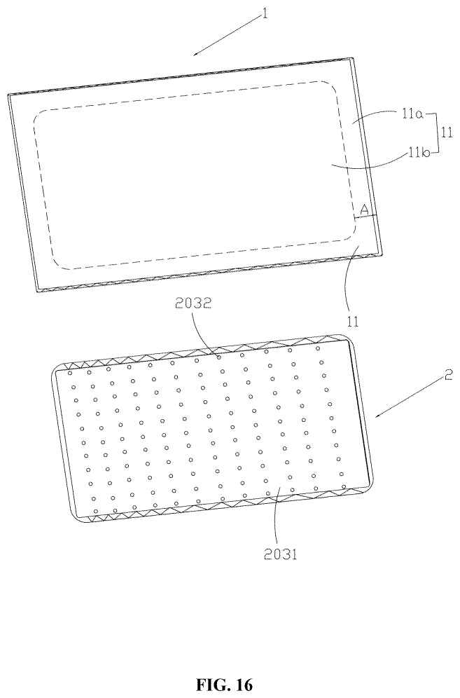

Furthermore, as shown in FIGS. 16 to 18, the lower carpet body 2 also includes an anti slip bottom layer 22 disposed on the second layer 42 away from the second attaching layer 21. The anti slip bottom layer 22 can be attached to the second layer 22 by hot melt adhesive spraying or hot melt adhesive roller rolling.

In this embodiment, the anti slip bottom layer 22 includes a bottom layer 2031 connected to the second layer 42 and multiple anti slip protrusions 2032 arranged on the side of the bottom layer 2031 of the second layer 42 away from the second layer 42. The anti slip protrusions 2032 are preferably arranged to cover the bottom layer 2031 of the second layer 42, which prevents the movement of the combined carpet when laid on the object surface 80, increases the stability of carpet laying, and also increases the safety of user use. Of course, in addition to setting the anti slip protrusions 2032, suction cups can also be used, but it is preferred to use multiple anti slip protrusions 2032.

Furthermore, the material of the anti slip protrusion 2032 includes plastic or rubber, or materials with strong friction.

The multiple anti slip protrusions 2032 can be attached to the bottom layer 2031 through hot pressing process, point molding process, hot melt adhesive spraying, or hot melt adhesive roller rolling. In some embodiments, the bottom layer 2031 may be omitted, and the multiple anti slip protrusions 2032 may be directly attached to the second layer 42 through hot pressing process, point molding process, hot melt adhesive spraying, or hot melt adhesive roller rolling.

Among them, regarding the formation of multiple anti slip protrusions 2032, the hot melt adhesive spraying process can be achieved by using patterned mesh covers in conjunction with spraying equipment, and the hot melt adhesive roller rolling process can be transferred or printed through patterned rollers.

Furthermore, the upper carpet body 1 also includes a first knitted edge 104 located on the side and top edges of the first layer 12 and the side and bottom edges of the first attaching layer 11. The first knitted edge 104 includes a first sewing thread layer 105 that is sewn and connected to the top edge of the first layer 12 and the bottom edge of the first attaching layer 11, and surrounds the side surfaces of the first layer 12 and the first attaching layer 11. Wrapping the edges of the first layer 12 and the first attaching layer 11 makes the appearance of the upper carpet body more neat and beautiful. The first sewing thread layer 105 is firmly fixed, and machine washing is not easy to break or separate. Even if there is damage, it is easy to mend. If adhesive is directly used to connect the two, the edges of the two layers can be clearly seen. Beautiful, and the two are easy to separate after machine washing, resulting in a poor user experience

Furthermore, the lower carpet body 2 also includes a second knitted edge 52 located on the side and top edges of the second attaching layer 21 and the side and bottom edges of the bottom layer 2031. The second knitted edge 52 includes a second sewing thread layer 521 that is sewn and connected to the top edge of the second attaching layer 21 and the bottom edge of the bottom layer 2031, and surrounds the side surfaces of the second attaching layer 21, the second layer 42, and the bottom layer 2031. The edge wrapping of the second layer 42 and the edge of the second attaching layer makes the overall appearance of the lower carpet body more neat and beautiful, and is firmly fixed with the second sewing thread layer 521, it is not easy to break or separate during machine washing, and even if there is damage, it is easy to mend; but if directly using adhesive to connect the two, two layers can be clearly seen at the edges, which is not aesthetically pleasing, and the two are easy to separate after machine washing, resulting in a poor user experience.

Furthermore, each layer of the upper carpet body 1 has a same surface area, and each layer of the lower carpet body 2 has a same surface area. The surface area of the upper carpet body 1 is greater than that of the lower carpet body 2, and the percentage of the surface area of the lower carpet body 2 to the surface area of the upper carpet body 1 is between 50% and 99.7%. It is preferred that the percentage of the surface area of the lower carpet body 2 to the surface area of the upper carpet body 1 is between 55% and 90%. Therefore, there is a buffering direction from the edge of the upper carpet body 1 towards the combination area of the upper carpet body 1 and the lower carpet body 2. The thinner upper carpet body 1 can better connect to the ground. In children's home use, children will not easily trip due to the high carpet, and the comfort of the combination area of the lower carpet body and the upper carpet body is higher. Overall, this structure improves the user experience. In the embodiments of the present invention, the specific shapes of the upper carpet body 1 and the lower carpet body 2 are not limited, and their projections on the floor can be rectangular, circular, or other shapes, as long as the percentage ratio of the area of the lower carpet body 2 to the area of the upper carpet body 1 is within the aforementioned range.

Furthermore, as shown in FIG. 16, the edge region 11a of the upper carpet body 1 corresponds to the edge region 11a of the first attaching layer 11 and is annular. The annular edge region 11a of the upper carpet body 1 is located on a periphery of the annular edge region of the lower carpet body 2 and is used to contact the object surface 8. The width A of the portion of the annular edge region 11a of the upper carpet body 1 that contacts the object surface 80 is in the range of 0.5 cm to 50 cm. The annular edge region 11a of the upper carpet body 1 refers to the area where the upper carpet body 1 is larger than the lower carpet body 2 and can directly contact the object surface 80. The width A of the annular edge region 11a should be in the range of 0.5 cm-50 cm, such as 2 cm-20 cm, which can be 2 cm, 5 cm, or 8 cm. 10 cm, 12 cm, 15 cm, the numerical value can also be other values, as long as it is within the aforementioned range, in this way, the combination area between the upper carpet body 1 and the lower carpet body 2 from the edge of the upper carpet body 1 is better buffered, improving the user's comfort level. In one embodiment, the width A is in the range of 2.5 cm to 3.5 cm

Furthermore, one of the first attaching layer 11 and the second attaching layer 21 is a hook surface layer 61, and the other of the first attaching layer 11 and the second attaching layer 21 is the loop layer 62, as shown in FIGS. 18, 19 to 22. The multiple hook shaped first fabric fibers 63 of the hook surface layer 61 can extend into and hook the multiple second fabric fibers 64 of the loop layer 62, so that the first attaching layer 11 and the second attaching layer 21 are bonded together, which can form static friction force. However, the first attaching layer 11 and the second attaching layer 21 have hook surface layers 61 or the loop layer 62 do not like a Velcro, in present application, the loop layer 62 is a soft layer, the side that is in contact with the hook surface layer 61 is suede, and the hook surface layer 61 is a hard layer, the side surface of the hook surface layer 61 opposite to the loop layer 62 has burrs, which is hook shaped, in this way, the first attaching layer 11 and the second attaching layer 21 are easily bonded together and form static friction force. This setting is based on the inherent characteristics of the materials used, and has a longer service life.

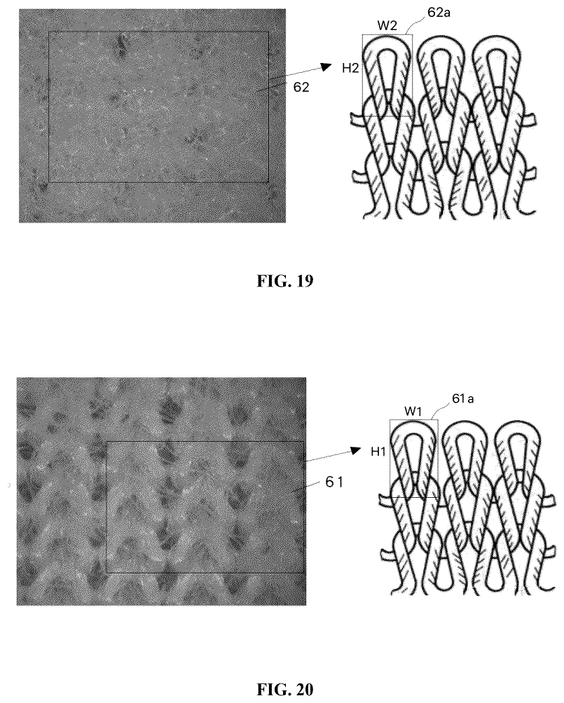

Furthermore, as shown in FIGS. 19-20, at least one of the hook surface layer 61 and the loop layer 62 is a weft knitted fabric layer. When both the hook surface layer 61 and the loop layer 62 are flat needle weft knitted fabric layers (i.e., fabric layers formed by using flat needle weft knitting method), if the first width of each weft knitted unit 61a in the hook surface layer 61 is greater than the second width of each weft knitted unit 62a in the loop layer 62, the static friction force is more stable. It can be understood that in this embodiment, both the hook surface layer 61 and the loop layer 62 are flat needle weft knitted fabric layers. The left side of FIG. 19 is an actual photo of the loop layer 62 in one embodiment, and the right side is a schematic diagram of the fabric structure in some areas of the actual photo, where each weft knitted unit 62a is the smallest repeating unit of the loop layer 62 fabric; on the left side of FIG. 20 is an actual photo of the hook surface layer 61 according to an embodiment, and on the right side is a schematic diagram of the fabric structure in some areas of the actual photo, where each weft knitting unit 61a is the smallest repeating unit of the hook surface layer 61.

Furthermore, for each weft knitting unit 61a of the hook surface layer 61, the first width W1 can be in the range of 700 um to 1500 um, with preferred first widths W1 being 800 um, 850 um, 900 um, 910 um, 950 um, 1000 um, which can also be other values as long as they are within the aforementioned range. For each weft knitted unit 62a of the loop layer 62, the second width W2 is in the range of 500 um to 1300 um, preferably 600 um, 700 um, 750 um, 800 um, 830 um, 850 um, 900 um, and its value can also be other values as long as it is within the aforementioned range. The first height H1 of each weft knitted unit 61a in the hook surface layer 61 is greater than the second height H2 of each weft knitted unit 62a in the loop layer 62; the first height H1 is in the range of 400 um to 1000 um, with preferred values of 600 um, 700 um, 710 um, 750 um, and 800 um, which can also be other values as long as they are within the aforementioned range; the second height H2 can be in the range of 300 um to 900 um, preferably in the values of 500 um, 550 um, 590 um, 600 um, 650 um, 700 um, and other values as long as they are within the aforementioned range.

A longitudinal density of the hook surface layer 61 is in the range of 6 coils/cm to 22 coils/cm, it is preferred that the longitudinal density of the hook surface layer 61 be in the range of 10 coils/cm, 12 coils/cm, 14 coils/cm, 16 coils/cm, and 18 coils/cm, and other values can be used as long as they are within the aforementioned range. A latitudinal density (i.e. transverse) of the hook surface layer 61 is in the range of 5 coils to 18 coils/cm, it is preferred that the latitudinal density of the hook surface layer 61 be in the range of 7 coils/cm, 9 coils/cm, 11 coils/cm, and 13 coils/cm, and other values can be used as long as they are within the aforementioned range. A longitudinal density of the loop layer 62 is in the range of 6 coils/cm to 22 coils/cm, with a preferred warp density of 92 coils/cm, 12 coils/cm, 15 coils/cm, 17 coils/cm, and 19 coils/cm, which can be other values as long as they are within the aforementioned range. The latitudinal density (i.e. transverse) of the loop layer 62 is in the range of 5 coils/cm to 18 coils/cm, with a preferred weft density of 8 coils/cm, 10 coils/cm, 12 coils/cm, 14 coils/cm, and 16 coils/cm, which can be other values as long as they are within the aforementioned range.

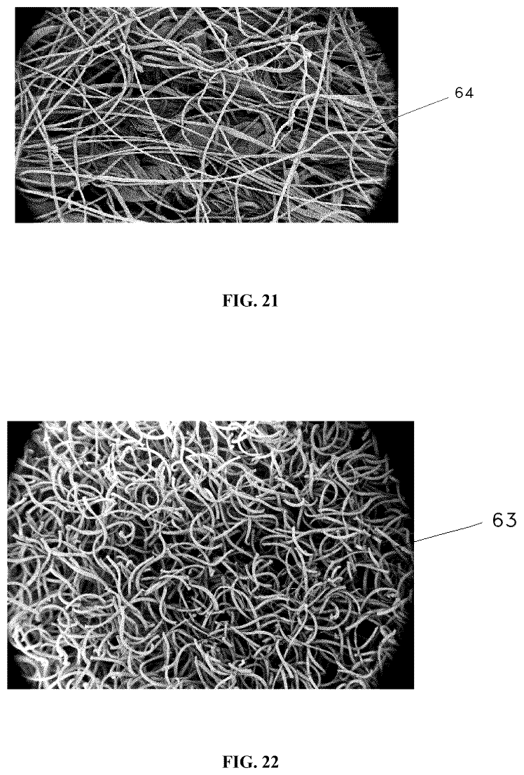

Furthermore, in this embodiment, FIGS. 21 and 22 show a microscopic view (fiber structure) of the first attaching layer 11 and the second attaching layer 21, a bending degree of most of the multiple first fabric fibers 63 is greater than that of most of the multiple second fabric fibers 64, so that the average curvature of the multiple first fabric fibers 63 can be greater than that of the multiple second fabric fibers 64. That is to say, the bending degree of the multiple first fabric fibers 63 is greater than that of the multiple second fabric fibers 64; the diameter of the first fabric fiber 63 is greater than or equal to the diameter of the second fabric fiber 64; the diameter of the first fabric fiber 63 and the second fabric fiber 64 is in the range of 10 um to 50 um, with a preferred diameter of 15 um, 16 um, 17 um, 18 um, 20 um, 22 um, 25 um. 30 um; the hardness of the first fabric fiber 63 is greater than that of the second fabric fiber 64.

Furthermore, both the first fabric fiber 63 and the second fabric fiber 64 consist of polyester fibers.

Furthermore, the material of the loop layer 62 may include Tencel and have undergone sandblasting treatment.

It can be understood that in the combination carpet of the above embodiment, one of the first attaching layer 11 and the second attaching layer 21 is the hook surface layer 61, and the other of the first attaching layer 11 and the second attaching layer 21 is the loop layer 62. The multiple hook shaped first fabric fibers 63 of the hook surface layer 61 extend into and hook the multiple second fabric fibers 64 of the loop layer 62, so that the first attaching layer 11 and the second attaching layer 21 are bonded together. Through the setting of the materials of the first attaching layer 11 and the second attaching layer 1221, as well as the parameters of the fabric fibers, the first attaching layer 11 and the second attaching layer 21 have hook surface layers 61 or loop layers 62. Unlike some existing Velcro adhesives with poor tactile sensation, the loop layer 62 is a soft layer and the velvet surface on the side that adheres to the hook surface layer 61, the hook surface layer 61 is a hard layer and has burrs (i.e. hook shaped) on the side surface thereof opposite to the loop layer 62. Due to the small fiber size and suitable range, it is not easy to cause the discomfort of ordinary Velcro. In addition, the first attaching layer 11 and the second attaching layer 21 are easily tightly adhered, mainly using the physical properties of the materials themselves, resulting in a longer service life.

In summary, compared to existing technologies, the combined carpet provided in embodiment seven of the present invention adopts the first attaching layer 11 and the second attaching layer 21 in contact, which can utilize the mechanical interlocking structure between the two to maintain relative stillness. When a person or animal walks on a carpet, the horizontal force is less than the mechanical interlocking force between the two, allowing them to continue to remain relatively stationary and avoid separation. Meanwhile, the detachable combination between the two allows the upper and lower blanket bodies to be used in combination or separately as needed. When used in combination, it can effectively increase the thickness of the carpet, making the combined carpet have good shock absorption and sound insulation effects, and high comfort; when some scenarios require separate use, the upper or lower carpet body can be used separately to diversify the usage scenarios of the combined carpet and enhance its versatility. In addition, due to the smaller size of the lower carpet body compared to the upper carpet body, it can be completely covered by the upper carpet body, so that the lower carpet body is always between the upper carpet body and the surface of the object such as the floor, thus keeping the lower carpet body clean and tidy. Therefore, the lower carpet body does not need to be cleaned frequently; when it is necessary to clean the carpet, simply clean and tidy the upper carpet body that is frequently in contact with it, at this time, directly separate the upper carpet body from the lower carpet body and clean it to keep the carpet clean and tidy.

It can be understood that in the seventh embodiment, the upper carpet body 1 is arranged on the lower carpet body 2, and most of its gravity is applied to the lower carpet body 2. However, the combination between the two is mainly through the mechanical interlocking structure's binding force, in this embodiment, the binding force of the mechanical interlocking structure can be greater than the gravity of the lower carpet body 2. Therefore, when the upper carpet body 1 is connected to the lower carpet body 2 as a whole, the lower carpet body 2 will not detach from the upper carpet body 1 when only the upper carpet body 1 is taken. Furthermore, the binding force of the mechanical interlocking structure may also be greater than the gravity of the upper carpet body 1, therefore, when the upper carpet body 1 is connected to the lower carpet body 2 as a whole, the upper carpet body 1 will not detach from the lower carpet body 2 when only the lower carpet body 2 is taken. However, in the first embodiment of present application, when only the upper carpet body 1 is picked up, the lower carpet body 2 may be separate from the lower carpet body 2 due to gravity.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

What is claimed is:

1. A combined carpet, comprising:
an upper carpet body comprising a first attaching layer;
a lower carpet body configured for being paved between the upper carpet and an object surface, and comprising a second attaching layer;
wherein the first attaching layer comprises a main area overlapping with the second attaching layer, and an edge area extending beyond the second attaching layer to contact the object surface and does not overlap with the second attaching layer, the main area of the first attaching layer and the second attaching layer realize a relative rest through a static friction force to prevent relative movement when the upper and lower carpet bodies are connected, thereby the upper carpet body and the lower carpet body are detachably connected.

2. The combined carpet according to claim 1, wherein the upper carpet body further comprises a first layer arranged on the first attaching layer away from the second attaching layer; and the lower carpet body further comprises a second layer arranged on the second attaching layer away from the first attaching layer, and the first layer is located on an outermost side of the upper part of the upper carpet body, used for contact with a user.

3. The combined carpet according to claim 1, wherein one of the first attaching layer and the second attaching layer is a hook surface layer having multiple hook shaped first fabric fibers, and the other one of the first attaching layer and the second attaching layer is a loop layer having multiple second fabric fibers, and the loop layer with the second fabric fibers is suede, which is softer than the hook surface layer with the first fabric fibers.

4. The combined carpet according to claim 2, wherein the upper carpet body further comprises a connecting layer located between the first layer and the first attaching layer.

5. The combined carpet according to claim 2, wherein a material of the first layer includes cotton, polyester, nylon, polypropylene, wool, and/or modal; and a material of the second layer includes wool, polyester, acrylic, synthetic fiber, non-woven fabric, sponge, and/or polypropylene.

6. The combined carpet according to claim 2, wherein the first attaching layer is an anti slip layer;
the anti slip layer comprises a rubber or plastic layer directly formed on the first layer or other adjacent layer by hot pressing, spot molding, hot melt adhesive spraying, or hot melt adhesive roller rolling; or
the anti slip layer further comprises a bottom layer formed above or below the rubber or plastic layer by hot pressing.

7. The combined carpet according to claim 2, wherein the lower carpet body further comprises an anti slip bottom layer disposed on the second layer away from the second attaching layer, and the anti slip bottom layer is attached to the second layer by hot melt adhesive spraying or hot melt adhesive roller rolling.

8. The combined carpet according to claim 7, wherein the anti slip bottom layer comprises a bottom layer connected to the second layer and multiple anti slip protrusions formed on the side of the bottom layer away from the second layer; the multiple anti slip protrusions are attached to the second layer by hot pressing or point molding process; a material for the anti slip protrusions includes plastic or rubber.

9. The combined carpet according to claim 2, wherein the upper carpet body further comprises a first knitted edge located on top edges and side edges of the first layer, and on side edges and bottom edges of the first attaching layer; and the first knitted edge comprises a first sewing thread layer sewn and connected to the top edges of the first layer and the bottom edges of the first attaching layer, and surrounding the side surfaces of the first layer and the first attaching layer.

10. The combined carpet according to claim 7, wherein the lower carpet body further comprises a second knitted edge located on top edges and side edges of the second attaching layer, on side edges of the second layer, and on bottom edges of the lower carpet body; and the second knitted edge comprises a second sewing thread layer sewn and connected to the top edges of the second attaching layer and the bottom edges of the lower carpet body, and surrounding the second attaching layer and the side surfaces of the second layer.

11. The combined carpet according to claim 1, wherein a surface area of the upper carpet body is greater than that of the lower carpet body, and a percentage of the surface area of the lower carpet body to the surface area of the upper carpet body is between 50% and 99.7%.

12. The combined carpet according to claim 1, wherein the edge area of the upper carpet body corresponding to the edge area of the first attaching layer and is annular, the annular edge area of the upper carpet body is located on a periphery of the lower carpet body and is used to contact the object surface, a width of the annular edge area of the upper carpet body that contacts the object surface is in the range of 0.5 cm to 50 cm.

13. The combined carpet according to claim 1, wherein one of the first attaching layer and the second attaching layer is a hook surface layer having multiple hook shaped first fabric fibers, and the other of the first attaching layer and the second attaching layer is a loop layer having multiple second fabric fibers;
the multiple hook shaped first fabric fibers of the hook surface layer extend into and hook onto the multiple second fabric fibers of the loop layer, allowing the main area of the first attaching layer to be detachably connected to the second attaching layer through static friction and mechanical interlocking force between the hook surface layer and the loop layer.

14. The combined carpet according to claim 13, wherein at least one of the hook surface layer and the loop layer is a weft knitted fabric layer having weft knitted units; when both the hook surface layer and the loop layer are flat needle weft knitted fabric layers, a first width of each weft knitted unit in the hook surface layer is greater than a second width of each weft knitted unit in the loop layer.

15. The combined carpet according to claim 14, wherein the first width is in the range of 700 um to 1500 um; the second width is in the range of 500 um to 1300 um; a first height of each weft knitted unit in the hook surface layer is greater than a second height of each weft knitted unit in the loop layer; the first height is in the range of 400 um to 1000 um; the second height is in the range of 300 um to 900 um; a longitudinal density of the hook surface layer is in the range of 6 coils/cm to 22 coils/cm, and a latitudinal density of the hook surface layer is in the range of 5 coils to 18 coils/cm; the latitudinal density of the loop layer ranges from 6 coils/cm to 22 coils/cm, and the latitudinal density of the loop layer ranges from 5 coils/cm to 18 coils/cm.

16. The combined carpet according to claim 13, wherein an average curvature of multiple first fabric fibers is greater than an average curvature of multiple second fabric fibers; the diameter of the first fabric fiber is greater than or equal to a diameter of the second fabric fiber, with the diameter of the first fabric fiber and the second fabric fiber each in the range of 10 um to 50 um; and a hardness of the first fabric fiber is greater than that of the second fabric fiber.

17. The combined carpet according to claim 13, wherein the first fabric fiber and the second fabric fiber both include polyester fibers; a material of the looped layer contains Tencel and has undergone sandblasting treatment.

18. The combined carpet according to claim 13, wherein a mechanical interlocking force is greater than a gravity of the lower carpet body.

19. A combined carpet, comprising:
an upper carpet body comprising a first layer, and a first attaching layer under the first layer;
a lower carpet body configured for being paved between the upper carpet and an object surface, and comprising a second attaching layer, and a second layer under the second attaching layer;
wherein the first attaching layer comprises a main area overlapping with the second attaching layer, and an edge area extending beyond the second attaching layer to contact the object surface and does not overlap with the second attaching layer, the main area of the first attaching layer and the second attaching layer realize a relative rest through a mechanical interlocking force to prevent relative movement when the upper and lower carpet bodies are connected, thereby the upper carpet body and the lower carpet body are detachably connected.

20. The combined carpet according to claim 19, wherein one of the first attaching layer and the second attaching layer is a hook surface layer having multiple hook shaped first fabric fibers, and the other of the first attaching layer and the second attaching layer is a loop layer having multiple second fabric fibers;
the multiple hook shaped first fabric fibers of the hook surface layer extend into and hook onto the multiple second fabric fibers of the loop layer, allowing the main area of the first attaching layer to be detachably connected to the second attaching layer.
